(19) United States
(12) Patent Application Publication
(10) Pub. No.: US 2011/0072260 A1
(43) Pub. Date: Mar. 24, 2011

(54) METHOD AND SYSTEM OF DOWNLOADABLE CONDITIONAL ACCESS USING DISTRIBUTED TRUSTED AUTHORITY

(75) Inventors: Han Seung KOO, Daejeon (KR); O Hyung KWON, Daejeon (KR); Soo In LEE, Daejeon (KR)

(73) Assignee: Electronics and Telecommunications Research Institute, Daejeon (KR)

(21) Appl. No.: 12/650,001

(22) Filed: Dec. 30, 2009

(30) Foreign Application Priority Data
Sep. 21, 2009 (KR) 10-2009-0089002

(51) Int. Cl. H04L 29/06

(52) U.S. Cl. 713/156

(57) ABSTRACT

Disclosed is a downloadable conditional access system (DCAS) and an operational method thereof that distributes a part of a function of a Trusted Authority to each multiple system operator (MSO) to enable the MSO server to process authentication with respect to a secure micro (SM) chip and a transport processor (TP) chip, and thus, a normal DCAS service is possible even when there is a problem with a security, and a DCAS host terminal for rental use is effectively operated.

### CROSS-REFERENCE TO RELATED APPLICATION

This application claims the benefit of Korean Patent Application No. 10-2009-0089002, filed on Sep. 21, 2009, in the Korean Intellectual Property Office, the disclosure of which is incorporated herein by reference.

### BACKGROUND

1. Field

The present invention relates to a technology that effective detects an illegally copied downloadable condition access system (DCAS) terminal from a DCAS system.

2. Description of the Related Art

A DCAS enables a cable service subscriber to freely purchase a settop box at retail regardless of a type of a multiple system operator (MSO) that the cable service subscriber joins, and also enables the cable service subscriber to continuously receive paid cable service without changing the settop box even when the cable service subscriber changes the MSO. Also, the cable service subscriber may change the DCAS with a DCAS of a different firm without changing a settop box distributed by a cable operator.

Accordingly, the subscriber may securely download, to a secure micro (SM) that is a secure chip in the settop box, images with respect to application programs that demand security, such as a Conditional Access System (CAS) application, a Digital Right Management (DMR) application, an Authorized Service Domain (ASD) application, by using the DCAS. In addition, the MSO may freely install and change the Conditional Access (CA) application, the DRM application, and the ASD application online.

### SUMMARY

An aspect of the present invention provides a downloadable conditional access system (DCAS) that distributively arranges secure micro (SM) authorization information in a central trusted authority (CTA) server and a distributed trusted authority (DTA) server, and thereby effectively detects a copied SM.

Another aspect of the present invention provides a DCAS that enables a multiple system operator (MSO) server to operate a DCAS host terminal for rental use based on the DTA server, regardless of the CTA server, and thus, the MSO server may operate various business models.

Another aspect of the present invention provides a DCAS that distributes a load of a service by authenticating, using a DTA server corresponding to each MSO server, a DCAS host terminal that requests access.

Another aspect of the present invention provides a DCAS that operates a DCAS service where an MSO takes full responsibility, when DCAS host terminals for rental use are utilized.

According to an aspect of the present invention, there is provided a DCAS including a CTA server to generate and distribute a certificate, and a DTA server to receive the certificate from the CTA, to store the received certificate, and to perform authentication with respect to a DCAS host terminal that attempts to access an MSO server. Here, the DTA server controls only the authenticated DCAS host terminal to access the MSO server.

According to an aspect of the present invention, there is provided a method of operation of a DCAS, including receiving a request for generating a certificate, generating the certificate in response to the received request for generating, and transmitting the generated certificate to an MSO server. Here, the transmitted certificate is used for authenticating a DCAS host terminal that attempts to access the MSO server.

Additional aspects and/or advantages will be set forth in part in the description which follows and, in part, will be apparent from the description, or may be learned by practice of the embodiments.

### EFFECT

According to an embodiment of the present invention, secure micro (SM) authorization information may be distributively arranged in a central trusted authority (CTA) server and a distributed trusted authority (DTA) server, and thus, an illegally copied SM may be effectively detected.

According to an embodiment of the present invention, a multiple system operator (MSO) server may operate a downloadable conditional access system (DCAS) host terminal for rental use based on the DTA server, regardless of the CTA server, and thus, the MSO server may operate various business models.

According to an embodiment of the present invention, a load of a service may be distributed by authenticating a DCAS host terminal that requests access by using a DTA server corresponding to each MSO server.

According to an embodiment of the present invention, when DCAS host terminals for rental are utilized, a DCAS service may be operated where an MSO takes full responsibility.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a downloadable conditional access system (DCAS) according to an embodiment of the present invention;

FIG. 2 is a diagram illustrating that a central trust authority (CTA) server generates and distributes a certificate for terminals for retail according to an embodiment of the present invention;

FIG. 3 is a diagram illustrating that a CTA server generates and distributes a certificate for a terminal for rental use according to an embodiment of the present invention;

FIG. 4 is a diagram illustrating that a CTA server and a distributed trusted authority (DTA) server transmit and receive state information for synchronization according to an embodiment of the present invention; and

FIG. 5 is a diagram illustrating a configuration that a CTA server and a DTA server process a join and leave of a DCAS host terminal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

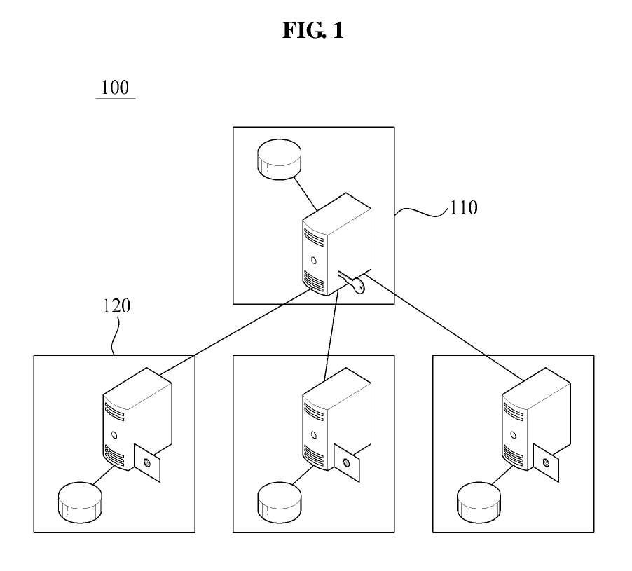

FIG. 1 is a diagram illustrating a downloadable conditional access system (DCAS) 100 according to an embodiment of the present invention.

The DCAS 100 according to an embodiment of the present invention includes a central trusted authority (CTA) server 110 and a distributed trusted authority (DTA) server 120.

The CTA server 110 may generate and distribute a certificate, and the DTA server may receive and store the distributed certificate and may authenticate a DCAS host terminal that attempts to access a multiple system operator (MSO).

In this instance, the DTA server 120 may control only the authenticated DCAS host terminal to access the MSO server.

The DCAS 100 according to an embodiment of the present invention may set an existing trusted authority (TA) as the CTA server 110, and may provide the DTA server 120 for each MSO server.

That is, the CTA server 110 may be located in the existing TA that is outside of the MSO server, and the DTA server 120 may be located in the MSO server, one DTA server for each MSO server.

The DTA server 120 may be installed for each MSO server, and may authenticate a transport processor (TP) and a secure micro (SM) and manages a state of the TP and the SM, based on whether a TP chip and an SM chip in the DCAST host terminal that attempts to access the MSO server are identical to identity (ID) information issued by the CTA server 110.

The DTA server 120 determines a validity of an SM ID and a TP ID, and whether a pair of the SM and the TP is identical to a pair registered in the CTA server 110. However, when the TP and the SM are in an original state, SM/TP pair information does not exist in the CTA server 110 and thus, the DTA server 120 does not perform a pairing check.

A single authentication proxy (AP) server or a plurality of AP servers may be connected to the DTA server 120, similar to a general DCAS configuration.

The CTA server 110 may generally generate/manage/distribute a certificate with respect to the TP chip and the SM chip contained in the DCAS host terminal and a DCAS headend-related server, and the certificate may be classified into a certificate for terminals for retail and a certificate for terminals for rental use.

More particularly, the certificate may be classified into the certificate for terminals for retail, to authenticate a DCAS host terminal for terminals for retail, and the certificate for terminals for rental use, to authenticate a DCAS host terminal for rental use.

The CTA server 110 may generate a same number of certificates for terminals for retail as a desired number of DCAS host terminals. That is, the same number of certificates for terminals for retail as the desired number of DCAS host terminals may be generated.

Accordingly, the CTA server 110 transmits the generated certificate for terminals for retail to a settop box vendor system and to the DTA server.

When the certificate is generated, the SM ID and the TP ID are respectively generated and inserted into a common name (CN) field. Also, when the certificate is the certificate for terminals for retail, the SM ID and the TP ID may be transmitted from the CTA server 110 to the DTA server 120 online or offline.

When the certificate is transmitted via online, messages defined in “certificate online transmission” may be used for the transmission, excluding the transmission of the certificate for terminals for retail.

The DTA server 120 may determine whether at least one of a TP chip and an SM chip of a DCAS host terminal that requests access to the MSO is identical to a certificate provided in advance from the CTA server 110, and determines whether the DCAS host terminal is authenticated whether to authenticate the DCAS host terminal.

Also, the CTA server 110 and the DTA server 120 may transmit and receive state information with respect to the DCAS host terminal.

According to an embodiment of the present invention, the DCAS 100 may receive a request for generating a certificate from a settop box vendor or the MSO server, and generate the certificate according to the received request. Then, the generated certificate may be transmitted to the MSO server. In this instance, the transmitted certificate may be used for authentication of the DCAS host terminal that attempts to access the MSO server.

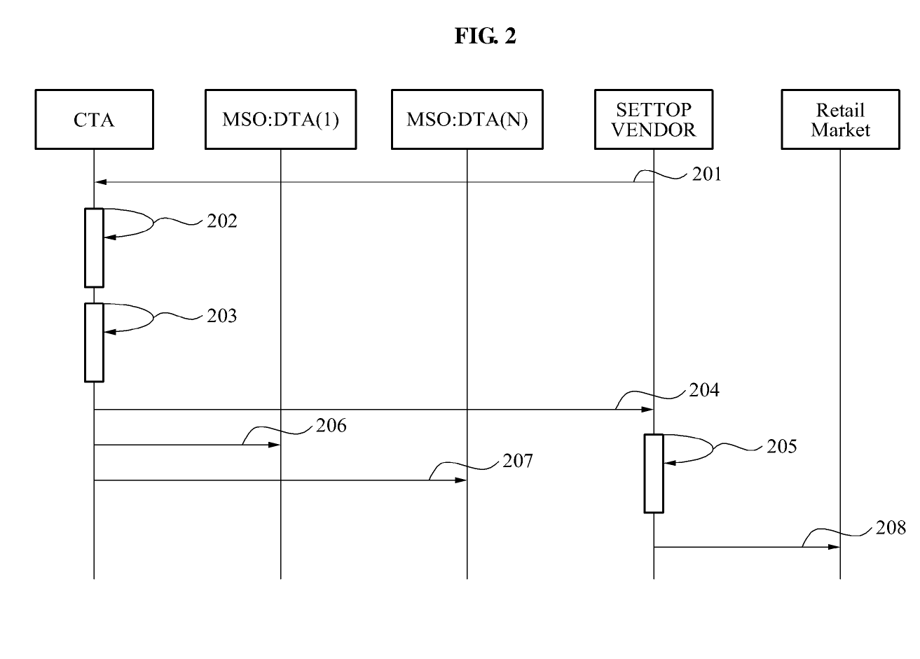

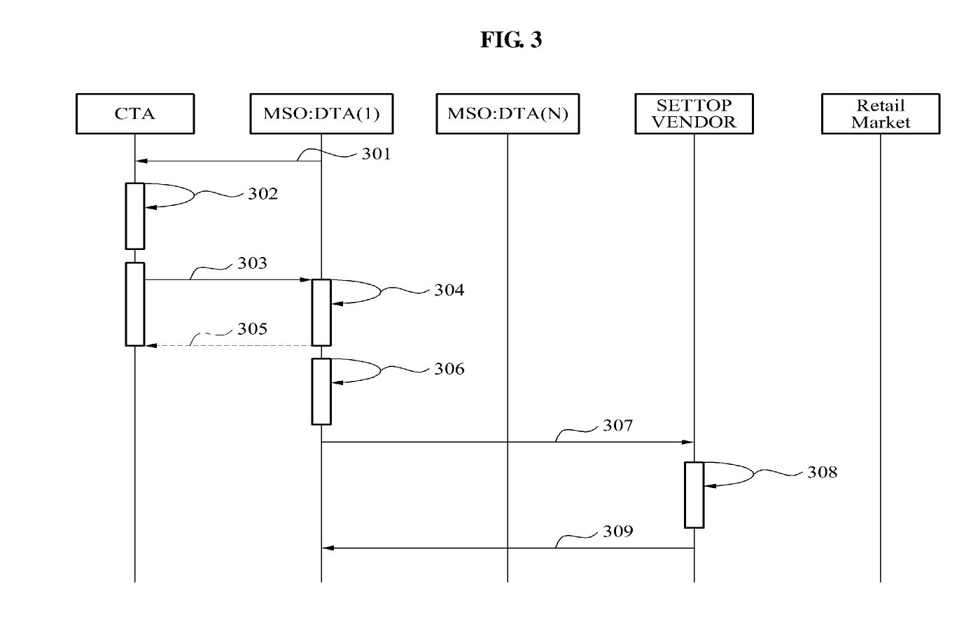

Hereinafter, example embodiments of an operational method of the DCAS 100 will be described with reference to FIGS. 2 and 3.

FIG. 2 is a diagram illustrating that a central trust authority (CTA) server generates and distributes a certificate for terminals for retail.

The CTA server 110 receives a request for a certificate from a settop box vendor in operation 201 and generates the certificate 202. In this instance, the settop box vendor may instruct the CTA server 110 to generate a same number of certificates as a desired number of DCAS host terminals and to transmit the generated certificates may order to generate a same number of certificates as a desired number of DCAS host terminals and to transmit the generated certificates to the CTA server 110.

The CTA server 110 may receive information of the settop box vendor and information about the number of certificates to be generated, and may generate certificates. The CTA server 110 may store the generated certificates in a database.

The generated certificates may be classified as a certificate for terminals for retail, to authenticate a DCAS host terminal used for retail. The CTA server 110 may store the certificate for terminals for retail in a portable storage device, such as a universal serial bus (USB) memory device, a CD, and the like, to transmit the certificate for terminals for retail to the settop box vendor.

The CTA server 110 may update certificate issue state information in a certificate generation information database, and may register the certificate for terminals for retail as being in an original state, in a database for synchronization of state information of the certificate for terminals for retail.

The CTA server 110 may transmit the generated certificate for terminals for retail to the settop box vendor in operation 204.

The settop box vendor may receive the certificate for terminals for retail offline, such as by post, a home-delivery service, and the like. The settop box vendor may utilize a certificate for terminals for retail of the SM chip or the TP chip when the settop box is manufactured in operation 205, and the manufactured DCAS settop box may be supplied to a retail market for sale.

According to an embodiment of the present invention, the CTA server 110 may provide an SM ID and a TP ID to the MSO server offline or online in operation 206. In this instance, the SM ID and the TP ID may be transmitted to a corresponding MSO server in operation S207.

The settop box that is manufactured and supplied to the retail market in operation may request to access the MSO server to use a service, and the SM ID and the TP ID may determine a validity of the settop box by matching the transmitted certificate for terminals for retail with the SM ID and the TP ID.

FIG. 3 is a diagram illustrating that a CTA server generates and distributes a certificate for a terminal for rental use according to an embodiment of the present invention.

The CTA server 110 receives a request for a certificate from an MSO server or the DTA server 120 in place of the MSO in operation 301, and generates the certificate in operation 302.

In this instance, the MSO server may request the CTA server 110 to generate a same number of certificates as a desired number of settop boxes and to transmit the generated certificates, to have its own settop box for rental use.

Accordingly, the CTA server 110 generates the requested certificate in operation 302. Also, the CTA server 110 may store the generated certificates in a database.

The generated certificates may be classified as a certificate for terminals for rental use, to authenticate a DCAS host terminal for rental use.

The CTA server 110 may transmit the generated certificate for terminals for rental use to the MSO server as a package in operation 303. According to an embodiment of the present invention, the certificate for terminals for rental use may be transmitted from the folder where the certificate for terminals for rental use is generated to a predetermined MSO server based on a certificate issue transmission protocol. A plurality of certificates for terminals for rental use are generated at once in a single folder, and the generated certificates for terminals for rental use may be defined as a single package. Each package may generate a SecureParameter.dat file, may record meta data that is certificate issue information, and may be transmitted together with the metadata.

The MSO server may receive the transmitted certificate for terminals for rental use, may temporally store the transmitted certificate for terminals for rental use in operation 304, and may respond to the CTA server 110 with respect to the reception result in operation 305.

The certificate issue state information is updated, in operation 306, in the database where the certificate generation information of the MSO server is stored, and a certificate of an original state may be registered in a retail certificate state information synchronization database.

When the update is processed, the MSO server may transmit the certificate for terminals for rental use to the settop box vendor offline to request manufacturing of the settop box in operation 307. Subsequently, the settop box vendor may receive the request, may manufacture the settop box in operation 308, and may supply to the MSO in operation 309.

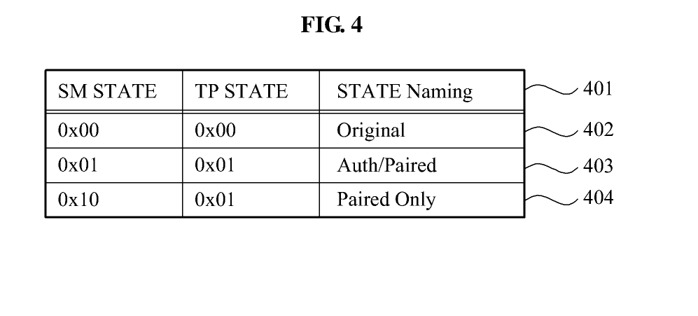

FIG. 4 is a diagram illustrating that a CTA server and a DTA server transmit and receive state information for synchronization according to an embodiment of the present invention.

The CTA server may transmit/receive state information with respect to a DCAS host terminal that attempts to access the DTA server and an MSO server, and may perform synchronization.

The state information may include at least one of paired date information about a date the DCAS host terminal initially accesses the MSO server and is authenticated, state information of the DCAS host terminal, an AP identifier (ID), a SM ID, and a TP ID.

The paired date information indicates the date when the DCAS host terminal initially accesses the MSO server and is normally authenticated after being manufactured at a factory. In this instance, the normal authentication indicates that a TP chip and an SM chip in the DCAS host terminal are determined, by a CTA server, as being valid and the SM chip and the TP chip are managed as a pair.

That is, the DTA server determines whether the SM chip and the TP chip of the DCAS host terminal that attempts to access the MSO server are corresponding to an SM ID and a TP ID generated by the CTA server, and determines whether the DCAS host terminal that attempts to access the MSO is authenticated.

In this instance, the state information of the DCAS host terminal may be defined as shown in a table of FIG. 4.

In FIG. 4, referring to a second row 402, when a state of an SM is “0x00” and a state of a TP is “0x00”, a corresponding state may be represented as Original information. Also, referring to a third row 403, when the state of the SM is “0x01” and the state of the TP is “0x01”, the corresponding state may be represented as Auth/Paired information. In addition, referring to a fourth row 404, when the state of the SM is “0x10” and the state of the TP is “0x01”, the corresponding state may be represented as Paired only information.

Accordingly, the state information of the DCAS host terminal may be represented by a combination of the state information of the TP chip and the state information of the SM chip of the DCAS host terminal.

For reference, the Original information may indicate that an access of the DCAS host terminal to the MSO server is an initial access after the DCAS host terminal is manufactured from the factory. Also, the Auth/Paired information may indicate the DCAS host terminal has accessed the MSO server and has been authenticated, and the Paired only information indicates that the DCAS host terminal currently leaves a service although the DCAS host terminal has been authenticated and has normally used the service in the past

The CTA server may continuously trace and manage the state information of the SM and the state information of the TP as the table of FIG. 4, and may perform synchronization of DTA servers and a database, and thus, all the DTA servers have the same state information of the SM and the same state information of the TP.

An SM/TP copy attack by a hacker may be prevented through the synchronization. That is, the synchronization may prevent copied DCAS host terminals from downloading DCAS client images through an illegal access to the MSO server.

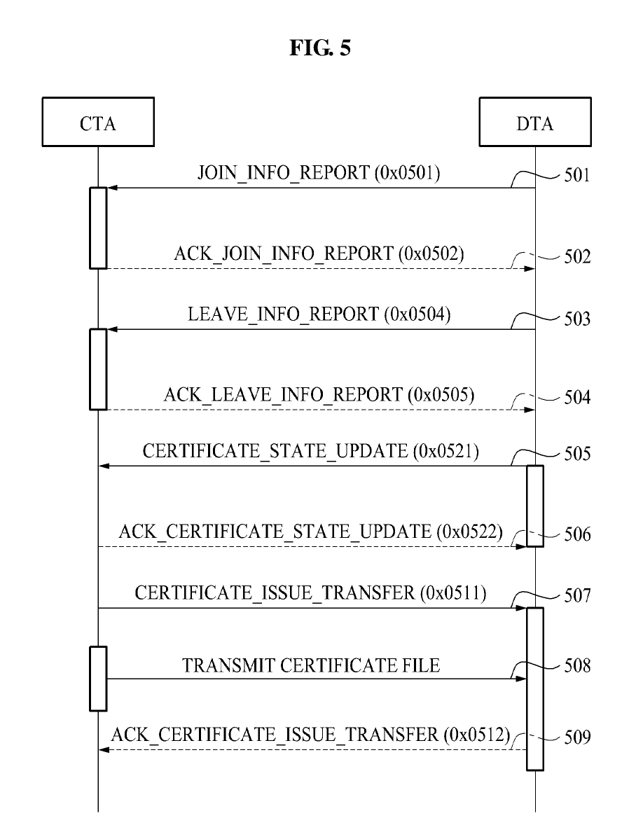

FIG. 5 is a diagram illustrating a configuration that a CTA server and a DTA server process a join and leave of a DCAS host terminal according to an embodiment of the present invention.

The CTA server updates its SM/TP state information whenever the CTA server receives a “JOIN_INFO_REPORT” message and a “LEAVE_INFO_REPORT” message from a predetermined DTA server, to ensure all DTA servers have the same SM/TP state information, and transmits a “CERTIFICATE_STATE_UPDATE” message to all the DTA servers through a “Retail STB state information update” message.

The DTA server according to an embodiment of the present invention may receive, from the DCAS host terminal, a join request signal and a leave request signal with respect to a service provided by the MSO server, and may perform a join process and a leave process.

Particularly, the DTA server may provide, to the CTA server, information about joining (pairing) of the DCAS host terminal in operation 501. Accordingly, the CTA server transmits an ACK signal with respect to the information provided from the DTA server in operation 502.

Also, according to a leave (disconnection) of the DCAS host terminal, the DTA server may report to the CTA server in operation 503 that the DCAS host terminal leaves, and the CTA server may transmit, to the DTA server, an ACK with respect to the report about the leave in operation 504.

The CTA server may receive, through an AP and the DTA server, DCAS host terminal information that accesses the DTA server.

In this instance, transmitted and received messages may be a JOIN_INFO_REPORT message, an ACK_JOIN_INFO_REPORT message, a LEAVE_INFO_REPORT message, and an ACK_LEAVE_INFO_REPORT message which correspond to “Retail STB join reporting” and a “Retail STB release reporting”. Also, information collected through the messages may be continuously monitored.

The DTA server may receive a join request for a “JoinReq” message from the AP, and may determine whether a value identical to an AP ID included in the “JoinReq” message exists in a database of the DTA server.

When the same AP ID exists in the database, the DTA server may determine whether a value identical to an SM ID included in the JoinReq message exists. Conversely, when the AP ID does not exist, the DTA server may transmits a caution message to a system administrator.

When the SM ID exists, the DTA server may perform the following process based on a SM state value stored in the database. First, when the SM state value is “0x01”, it indicates that authentication is requested once again even though an SM is already in an Auth/Paired state. Accordingly, it is determined that the SM ID that currently requests access may be an illegal copy by a hacker.

As another example, when the SM state value is “0x10”, it indicates that the SM ID joined the service in the past and currently leaves the service. In this instance, the DTA server may determines whether a TP ID included in the JoinReq message is identical to a TP ID that the database of the DTA server stores as a pair value of the SM ID.

When the TP ID of JoinReq message and the TP ID of the database of the DTA server are identical, the DTA server may change state information of the corresponding SM into “0x01”, may perform a join process to join the service, and may transmit a JoinInfo message to the CTA server.

Conversely, when the TP of the JoinReq message and the TP ID of the database of the DTA server are different from each other, it may be understood as a case that a pair of the SM ID is changed. In this instance, the DTA server may refuse a join request from the corresponding DCAS host terminal.

Also, when the SM state value is “0x00”, it indicates that the SM ID is mounted on the DCAS host terminal and makes an initial request to join a DCAS service after being manufactured at a factory. Accordingly, the DTA server may change the SM state information into “0x01”, and may register the TP ID included in the JoinReq message in the DTA server database. Next, the DTA server transmits the JoinInfo to the CTA server.

When the SM state value are different from “0x00”, “0x01”, and “0x10”, the DTA server may transmit an error report to a system and may refuse a request of the DCAS host terminal for joining the DCAS service.

To request a leave of the DCAS host terminal, the DTA server may receive a request for a “LeaveReq” message from the AP.

In this instance, the DTA server may determine whether a value identical to an AP ID included in the LeaveReq message exists in a database of the DTA server.

When the AP ID exists in the database, the DTA server may determine whether a value identical to an SM ID included in the LeaveReq message exists in the database. Conversely, when the AP ID does not exist in the database, the DTA server may transmit a warning message to the system.

When the SM ID exists, the DTA server may perform the following process based on a SM state value stored in the database.

When the SM state value is “0x00” or “0x10”, it indicates that an SM requests for a leave although the SM is currently not joining the service, In this instance, the DTA server may refuse a leave request and may transmit a warning message to the system.

When the SM state value is “0x01”, it indicates that the SM is currently joining the service. In this instance, the DTA server may change the SM state information into “0x10” and perform a leave process of the corresponding SM ID to leave the service. Subsequently, the DTA server transmits a LeaveInfo message to the CTA server.

The DTA server may request the CTA server to update state information of a settop box in response to the JOIN_INFO_REPORT message based on the join and the LEAVE_INFO_REPORT message based on the leave in operation 505, and the CTA server may transmit an ACK to the DTA server in response to the request, and may update the state information in operation 506.

Also, the CTA server may transmit, to the DTA server, a certificate requested by the DTA server in operation 507 and 508, and may receive an ACK with respect to the transmitted certificate in operation 509.

Accordingly, a DCAS and a method thereof according to an embodiment of the present invention may distributively arrange SM authorization information in the CTA server and the DTA server, and thereby effectively detecting a copied SM.

In addition, according to an embodiment of the present invention, the MSO server may operate a DCAS host terminal for rental use based on the DTA server, regardless of the CTA server, and thus, the MSO server may operate various business models.

The method of operation of the DCAS according to the exemplary embodiments of the present invention includes computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

According to an embodiment of the present invention, SM authorization information may be distributively arranged in the CTA server and the DTA server, and thus, a copied SM may be effectively detected.

According to an embodiment of the present invention, an MSO server may operate a DCAS host terminal for rental use based on the DTA server, regardless of the CTA server, and thus, the MSO server may operate various business models.

According to an embodiment of the present invention, a load of a service may be distributed by authenticating a DCAS host terminal that requests access by using a DTA server corresponding to each MSO server.

According to an embodiment of the present invention, when DCAS host terminals for rental use are utilized, a DCAS service may be operated where an MSO takes full responsibility.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A downloadable conditional access system (DCAS), comprising:
a central trusted authority (CTA) server to generate and distribute a certificate; and
a distributed trusted authority (DTA) server to receive the certificate from the CTA, to store the received certificate, and to perform authentication with respect to a DCAS host terminal that attempts to access a multiple system operator (MSO) server,
wherein the DTA server controls only the authenticated DCAS host terminal to access the MSO server.

2. The DCAS of claim 1, wherein the certificate generated by the CTA server is authenticated by determining whether the certificate is corresponding to at least one of a transport processor (TP) chip and a secure micro (SM) chip of the DCAS host terminal.

3. The DCAS of claim 1, wherein:
the certificate is a certificate used for DCAS host terminals for retail, to authenticate a DCAST host terminal for retail; and
the CTA server generates a same number of certificates for DCAS host terminals for retail as a desired number of DCAS host terminals, and transmits the generated certificates for DCAS host terminals for retail to a settop box vendor system and to the DTA server.

4. The DCAS of claim 1, wherein:
the certificate is a certificate used for DCAS host terminals for rental use, to authenticate a DCAST host terminal for rental use; and
the CTA server generates the certificate for DCAS host terminals for rental use based on multiple system operator (MSO) information with respect to a MSO server that provides a rental service and a number of DCAS host terminals that are desired to be generated, and transmits the generated certificate for DCAS host terminals for rental use to the MSO server and to the DTA server.

5. The DCAS of claim 1, wherein the CTA server receives state information with respect to the DCAS host terminal that intends to access an MSO server from the DTA server.

6. The DCAS of claim 5, wherein the state information comprises at least one of paired date information about a date the DCAS host terminal initially accesses the MSO server and is authenticated, state information of the DCAS host terminal, an authentication proxy (AP) identifier, a secure micro (SM) identifier, and a transport processor (TP) identifier.

7. The DCAS of claim 6, wherein the state information of the DCAS host terminal comprises original information indicating whether an access of the DCAS host terminal is an initial access to the MSO server after being manufactured at a factory, Auth/Paired information indicating whether the DCAS host terminal accesses the MSO server and is authenticated, and leave information indicating that the DCAS host terminal currently leaves a service where the DCAS host terminal has been authenticated and has normally used the service in the past.

8. The DCAS of claim 7, wherein the state information of the DCAS host terminal is represented by a combination of a state of a TP chip and a state of an SM chip of the DCAS host terminal.

9. The DCAS of claim 5, wherein the CTA server transmits the received state information with respect to the DCAS host terminal to all other accessible DTA servers.

10. The DCAS of claim 1, wherein the DTA server determines whether a TP chip and an SM chip of the DCAS host terminal that attempts to access the MSO are corresponding to an SM identifier and a TP identifier generated by the CTA server, and determines whether the DCAS host terminal that attempts to access the MSO is authenticated whether to authenticate the DCAS host terminal.

11. The DCAS of claim 1, wherein the DTA server receives, from the DCAS host terminal, a join request signal and a leave request signal with respect to a service provided by the MSO server, and performs a join process and a leave process.

12. A method of operation of a DCAS, comprising:
receiving a request for generating a certificate;
generating the certificate in response to the received request for generating; and
transmitting the generated certificate to an MSO server,
wherein the transmitted certificate is used for authenticating a DCAS host terminal that attempts to access the MSO server.

13. The DCAS of claim 12, wherein the certificate is used for authenticating a DCAS host terminal for retail or a DCAS host terminal for rental use.

14. The DCAS of claim 12, further comprising:
changing state information corresponding to the generated certificate; and
transmitting the changed state information to all other accessible DTA servers to share the changed state information.
